(19) United States
(12) Patent Application Publication
(10) Pub. No.: US 2026/0301313 A1
(43) Pub. Date: Oct. 1, 2026

(54) INFORMATION PROCESSING SYSTEM, METHOD FOR DETERMINING LIGHTING ARRANGEMENT, AND NON-TRANSITORY COMPUTER READABLE MEDIUM

(71) Applicant: FUJIFILM Business Innovation Corp., Tokyo (JP)

(72) Inventors: Kiyofumi AIKAWA, Kanagawa (JP); Yoshitaka Kuwada, Kanagawa (JP); Kazuya Fukunaga, Kanagawa (JP); Kaito Tasaki, Kanagawa (JP); Kiyoshi Iida, Kanagawa (JP)

(73) Assignee: FUJIFILM Business Innovation Corp., Tokyo (JP)

(21) Appl. No.: 19/280,594

(22) Filed: Jul. 25, 2025

(30) Foreign Application Priority Data
Mar. 26, 2025 (JP) 2025-051834

(51) Int. Cl. G06T 15/50; G06T 11/00; G06T 15/04

(52) U.S. Cl. CPC G06T 15/506; G06T 11/10; G06T 15/04

(57) ABSTRACT

An information processing system includes a processor configured to: arrange a three-dimensional model in a virtual space; arrange a surface light source that illuminates the three-dimensional model in the virtual space; arrange a camera that captures the three-dimensional model in the virtual space; generate a two-dimensional map having a correspondence relationship with a surface of the three-dimensional model; capture, from multiple viewpoints, a state where the three-dimensional model having a texture parameter for specular reflection set for the entire surface is illuminated by the surface light source and generate a multi-viewpoint specular reflection image; associate the multi-viewpoint specular reflection image with the two-dimensional map and generate a two-dimensional specular reflection map; and attach the generated two-dimensional specular reflection map to the three-dimensional model and visualize a specular reflection region.

### CROSS-REFERENCE TO RELATED APPLICATIONS

This application is based on and claims priority under 35 USC 119 from Japanese Patent Application No. 2025-051834 filed Mar. 26, 2025.

### BACKGROUND

### (i) Technical Field

The present disclosure relates to an information processing system, a method for determining lighting arrangement, and a non-transitory computer readable medium.

### (ii) Related Art

There is a technique for capturing an existing three-dimensional object from a plurality of directions and reproducing a three-dimensional model on a computer. To acquire specular reflection images of all the surfaces of the three-dimensional object, as many lighting devices as possible may be arranged.

Examples of the related art include Japanese Unexamined Patent Application Publication No. 2021-72024.

### SUMMARY

However, an increase in the number of lighting devices causes an increase in the size of the apparatus configuration and complicated control. Further, there is no scheme for verifying the number and arrangement of lighting devices used to reproduce the three-dimensional model.

Aspects of non-limiting embodiments of the present disclosure relate to visualizing a specular reflection region of a three-dimensional object that can be captured based on the number and the arrangement of lighting devices.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: arrange a three-dimensional model in a virtual space; arrange a surface light source that illuminates the three-dimensional model in the virtual space; arrange a camera that captures the three-dimensional model in the virtual space, generate a two-dimensional map having a correspondence relationship with a surface of the three-dimensional model; capture, from multiple viewpoints, a state where the three-dimensional model having a texture parameter for specular reflection set for the entire surface is illuminated by the surface light source and generate a multi-viewpoint specular reflection image; associate the multi-viewpoint specular reflection image with the two-dimensional map and generate a two-dimensional specular reflection map; and attach the generated two-dimensional specular reflection map to the three-dimensional model and visualize a specular reflection region.

### BRIEF DESCRIPTION OF THE DRAWINGS

Exemplary embodiments of the present disclosure will be described in detail based on the following figures, wherein:

FIG. 1 is a side view of a gloss reading system that reads gloss information from a three-dimensional object existing in the real space;

FIG. 2 is a top view of the gloss reading system that reads gloss information from the three-dimensional object existing in the real space;

FIG. 3 is a diagram illustrating a schematic configuration of a system that visualizes a specular reflection region of a three-dimensional model;

FIG. 4 is a diagram illustrating an example of a hardware configuration of a simulation apparatus;

FIG. 5 is a flowchart illustrating processing to visualize a specular reflection region;

FIG. 6 is a diagram illustrating a processing image of step S4 (see FIG. 5);

FIG. 7 is a flowchart illustrating an example of a processing operation executed in step S4 (see FIG. 5);

FIG. 8 is a diagram illustrating simulation processing executed in FIG. 7;

FIG. 9 is a diagram illustrating photogrammetry processing;

FIG. 10 is a diagram illustrating a multi-viewpoint image of a three-dimensional model reflecting a texture parameter of specular reflection;

FIG. 11 is a flowchart illustrating an example of a processing operation executed in step S8 (see FIG. 5);

FIG. 12 is a diagram illustrating a processing image of step S8 (see FIG. 5);

FIG. 13 is a diagram illustrating an example of a three-dimensional model obtained by visualizing a specular reflection region;

FIG. 14 is a diagram illustrating a display example of a specular cover rate screen;

FIG. 15 is a flowchart illustrating processing to determine light source arrangement; and

FIG. 16 is a diagram illustrating a recommendation screen for light source arrangement.

### DETAILED DESCRIPTION

Exemplary embodiments of the invention will be described below with reference to the drawings.

### First Exemplary Embodiment

### <Gloss Reading System Configuration>

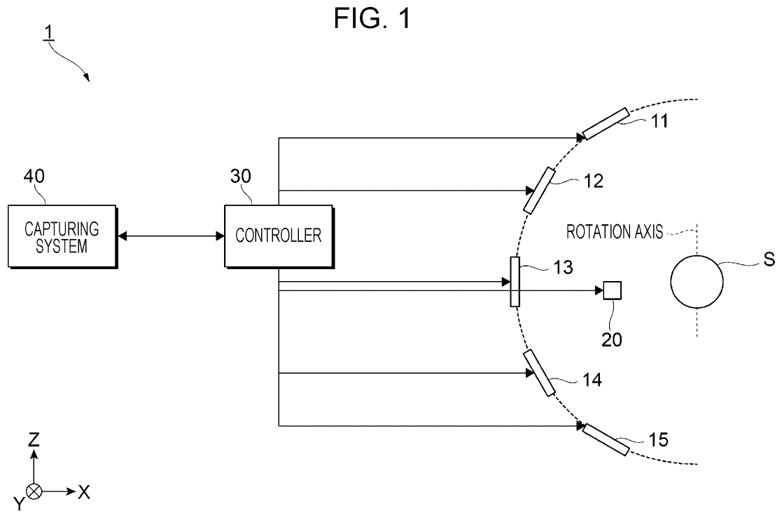

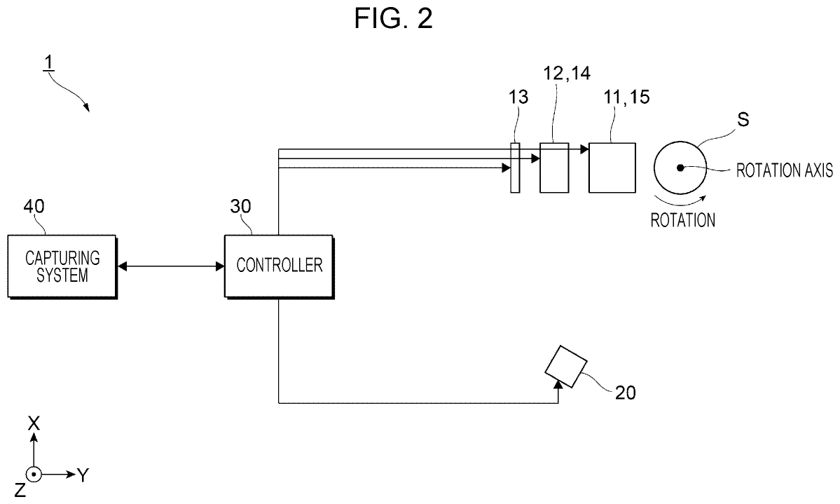

FIG. 1 is a side view of a gloss reading system 1 that reads gloss information from a three-dimensional object S existing in the real space. FIG. 2 is a top view of the gloss reading system 1 that reads gloss information from the three-dimensional object S existing in the real space. In FIG. 2, the parts corresponding to those in FIG. 1 are denoted by the corresponding reference numerals.

The three-dimensional object S illustrated in FIGS. 1 and 2 is a sphere. However, the shape of the three-dimensional object S to be read by the gloss reading system 1 is not limited to a sphere and may be any shape. In the case of FIGS. 1 and 2, the three-dimensional object S is attached to a rotating table (not illustrated) whose rotation axis is the Z-axis. The Z-axis coincides with the direction normal to the XY plane including the X-axis and the Y-axis. While the rotation axis passes through the center of the sphere in FIGS. 1 and 2, the rotation axis does not need to pass through the center or the center of gravity of the three-dimensional object S.

The gloss reading system 1 includes light sources 11 to 15 that illuminate the three-dimensional object S from the surroundings, a camera 20 that captures the three-dimensional object S illuminated with illumination light, a controller 30 that controls the light sources 11 to 15 and the camera 20, and a capturing system 40 that controls the entire system. The capturing system 40 may include the controller 30.

Each of the light sources 11 to 15 is a surface light source. According to the present exemplary embodiment, five surface light sources are arranged. The number of surface light sources may be two or more, three, or ten. The surface light source may be a collimated light source or a non-collimated light source (i.e., a diffuse light source).

In the case of FIG. 1, the light sources 11 to 15 are arranged at different heights in an arc shape. With the arc-shaped arrangement, the distances from the light sources 11 to 15 to the three-dimensional object S are substantially equal.

While the number of arcs is one in FIG. 1, a plurality of arcs may be provided.

In the case of FIG. 1, the light source 13 illuminates the vicinity of the equator of the three-dimensional object S. The light sources 11 and 12 illuminate the upper hemisphere of the three-dimensional object S obliquely from above. The light sources 14 and 15 illuminate the lower hemisphere of the three-dimensional object S obliquely from below.

While no surface light sources are arranged directly above and directly below in the arrangement illustrated in FIGS. 1 and 2, surface light sources may be arranged at these positions as well.

The camera 20 is a device that captures a surface image of the three-dimensional object S illuminated by the light sources 11 to 15. As an image sensor of the camera 20, for example, a complementary metal-oxide semiconductor (CMOS) sensor is used.

In the case of FIG. 1, the capturing optical axis of the camera 20 is included in a plane that includes the equator of the sphere (i.e., the three-dimensional object S). Specifically, the camera 20 is attached at a position where the camera 20 captures the sphere (i.e., the three-dimensional object S) from directly beside the sphere.

While the number of the cameras 20 illustrated in FIGS. 1 and 2 is one, the number of the cameras 20 may be two or more. The position and the capturing direction (i.e., the direction of the capturing axis) of the camera 20 may be variable. When the position and the capturing direction of the camera 20 are changed, the positional relationship between the light sources 11 to 15 and the camera 20 is changed. Accordingly, it is possible to acquire more gloss information from the three-dimensional object S.

Images captured by the camera 20 may be still images or moving images.

The controller 30 controls the light sources 11 to 15 to be turned on and off one by one. Therefore, only one of the light sources 11 to 15 may be turned on, or all of the five light sources 11 to 15 may be turned on. Only two of the light sources 11 to 15 may be turned on, only three of the light sources 11 to 15 may be turned on, or only four of the light sources 11 to 15 may be turned on.

The controller 30 controls capturing of the three-dimensional object S by the camera 20.

The controller 30 also controls the rotation of a rotating table (not illustrated). For example, the controller 30 rotates the rotating table by a predetermined unit rotation angle.

The capturing system 40 gives an instruction for the capturing timing of the three-dimensional object S by the camera 20. For example, the capturing system 40 sets the controller 30 to capture the three-dimensional object S each time the rotating table is rotated by the predetermined unit rotation angle.

The capturing system 40 acquires an image of the three-dimensional object S from the controller 30 and accumulates the image. The images of the three-dimensional object S accumulated in the capturing system 40 are used, for example, to simulate how the three-dimensional object S looks glossy.

### <Specular Reflection Region Visualization System>

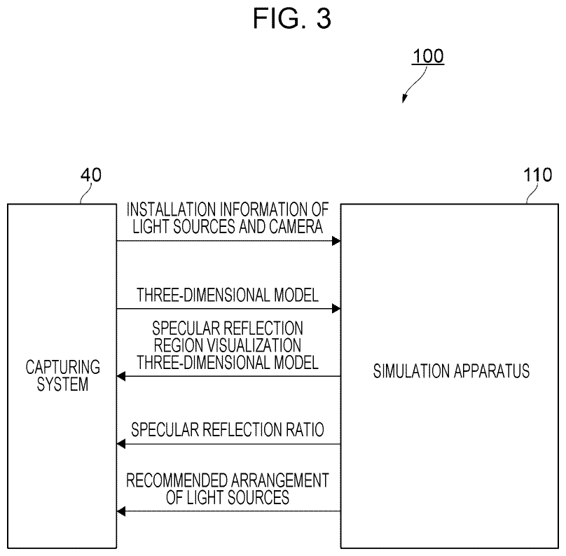

FIG. 3 is a diagram illustrating a schematic configuration of a system 100 that visualizes a specular reflection region of a three-dimensional model M. In FIG. 3, the parts corresponding to those in FIGS. 1 and 2 are denoted by the corresponding reference numerals.

Hereinafter, the system 100 that visualizes the specular reflection region of the three-dimensional model M is referred to as the “specular reflection region visualization system 100”.

The specular reflection region visualization system 100 illustrated in FIG. 3 includes the capturing system 40 and a simulation apparatus 110.

According to the present exemplary embodiment, the capturing system 40 and the simulation apparatus 110 are connected to each other via a signal line or a network (not illustrated). The capturing system 40 and the simulation apparatus 110 may be connected to each other via a wire or wirelessly.

The capturing system 40 provides the simulation apparatus 110 with installation information of the light sources 11 to 15 (see FIG. 1) and installation information of the camera 20 (see FIG. 1) included in the gloss reading system 1 (see FIG. 1). In the case of FIG. 3, for example, the coordinates of each of the light sources 11 to 15, the coordinates of the camera 20, the size of each of the light sources 11 to 15, and the angle of view of the camera 20 are given as the installation information. Based on these pieces of information, the virtual light source and the virtual camera are arranged in the simulation space.

The capturing system 40 provides the simulation apparatus 110 with the three-dimensional model of the representative shape to be used for simulation. The number of three-dimensional models of representative shapes may be one or more. Examples of representative shapes include a sphere, a cylinder, a torus, and a figure. In the following description, a sphere is used as a representative shape.

The simulation apparatus 110 provides the capturing system 40 with, for example, the three-dimensional model (hereinafter also referred to as the “specular reflection region visualization model”) in which the specular reflection region is visualized for each combination of arranged virtual light sources. For example, specular reflection region visualization models are generated, which correspond to the number obtained by multiplying the number of combinations (that is, 31 combinations) of the five light sources 11 to 15 by the number of three-dimensional models.

The simulation apparatus 110 provides the capturing system 40 with, for example, the ratio (hereinafter referred to as the “specular reflection ratio”) of the specular reflection region to the entire surface for each combination of arranged virtual light sources.

The specular reflection ratio is calculated as the ratio of the specular reflection region to the surface area of the three-dimensional model used in simulation.

The simulation apparatus 110 provides the capturing system 40 with, for example, the recommended arrangement of virtual light sources. With regard to each three-dimensional model, the combination of one or more virtual light sources arranged is given, where the ratio of the specular reflection region is equal to or more than a predetermined value (e.g., 70%). As long as the predetermined value is satisfied, a plurality of combinations may be output.

The simulation apparatus 110 is an example of an information processing system.

### <Hardware Configuration>

### <Simulation Apparatus>

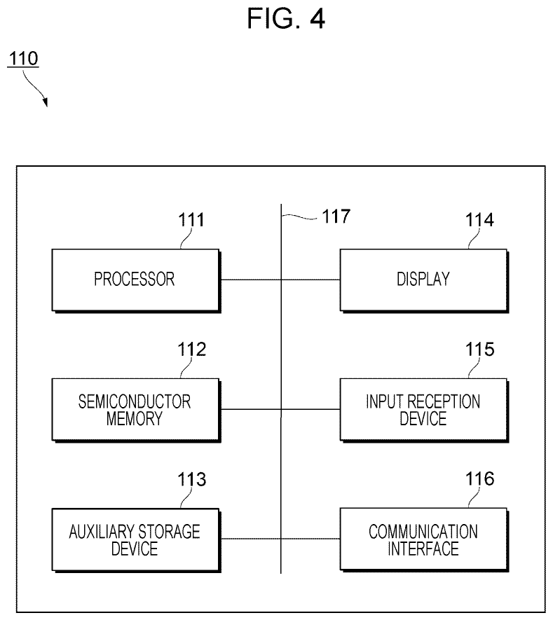

FIG. 4 is a diagram illustrating an example of a hardware configuration of the simulation apparatus 110.

The simulation apparatus 110 illustrated in FIG. 4 includes a processor 111, a semiconductor memory 112, an auxiliary storage device 113, a display 114, an input reception device 115, and a communication interface 116. These devices are connected to one another via a signal line 117 such as a bus.

The processor 111 is a device that performs various functions by executing programs.

The semiconductor memory 112 may include, for example, a read only memory (ROM) in which a unified extensible firmware interface (UEFI) or the like is stored and a random access memory (RAM) used as a work area of the processor 111.

The processor 111 and the semiconductor memory 112 function as what is called a computer.

The auxiliary storage device 113 includes, for example, a hard disk device or a semiconductor storage. The auxiliary storage device 113 stores programs and various types of data. The term “program” is used as a generic term for an operating system (OS) and an application program. The auxiliary storage device 113 stores, as one of the programs, a program for simulating a specular reflection region for each arrangement of virtual light sources.

The display 114 displays a simulation result and the like. As the display 114, for example, a liquid crystal display or an organic electroluminescence (EL) display is used.

The input reception device 115 is a device that receives an input operation from, for example, a mouse, a keyboard, a button, or another input device.

The communication interface 116 is an interface for communicating with the capturing system 40 (see FIG. 3) via the network N. The communication interface 116 supports various communication standards. Examples of the communication standard include Ethernet (registered trademark), Wi-Fi (registered trademark), and a mobile communication system.

### <Specular Reflection Region Visualization Processing>

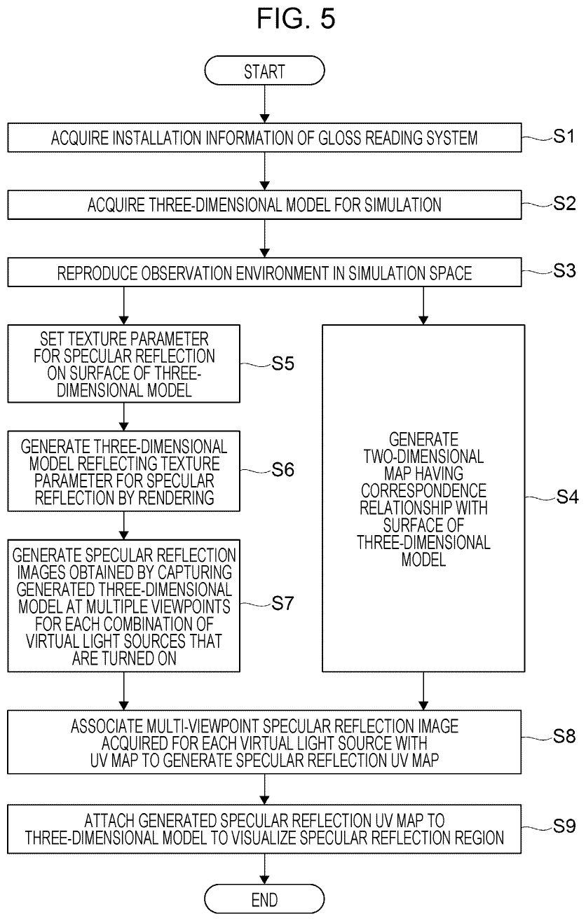

FIG. 5 is a flowchart illustrating processing to visualize a specular reflection region. The symbol S illustrated in the drawings represents a step.

The processing operations illustrated in FIG. 5 are performed through program execution by the processor 111 (see FIG. 4).

### <Processing Contents of Steps S1 to S3>

First, the processor 111 acquires the installation information of the gloss reading system 1 (see FIG. 1) (step S1). Specifically, the processor 111 acquires the coordinates of each of the light sources 11 to 15 (see FIG. 1) included in the gloss reading system 1, the coordinates of the camera 20 (see FIG. 1), the size of each of the light sources 11 to 15, and the field of view of the camera 20.

Subsequently, the processor 111 acquires the three-dimensional model M for simulation (step S2). In the case described below, the three-dimensional model M for simulation is a “sphere”. For the three-dimensional model M for simulation, a plurality of representative shapes having different shapes and sizes is acquired.

Subsequently, the processor 111 reproduces an observation environment in the simulation space (step S3). That is, the observation environment of the gloss reading system 1 is reproduced in the simulation space. Specifically, a virtual light source, a virtual camera, and the three-dimensional model M are arranged in the simulation space.

Thus, preparation for the simulation is complete.

According to the present exemplary embodiment, when preparation for the simulation is complete, the processor 111 executes two types of processing in parallel.

One is processing (step S4) to generate a two-dimensional map having a correspondence relationship with the surface of the three-dimensional model M.

Another processing is processing (steps S5 to S7) to set a specular reflection region in the three-dimensional model M and simulate the images captured from multiple viewpoints while one of the light sources 11 to 15 is turned on.

<Processing contents of Step S4>

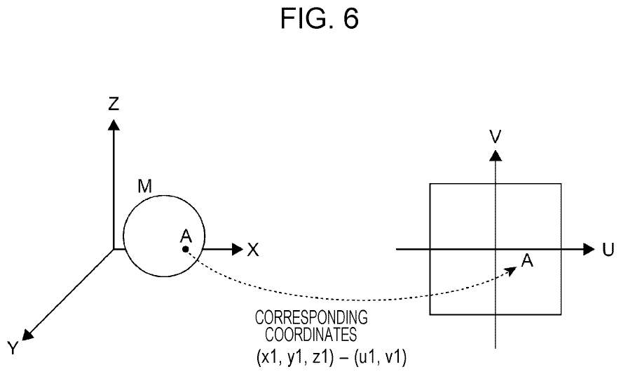

FIG. 6 is a diagram illustrating a processing image of step S4 (see FIG. 5). In the case of FIG. 6, the coordinates of the three-dimensional model M are represented as the XYZ coordinate system (x1, y1, z1), and the coordinates of the two-dimensional map are represented as the UV coordinate system (u1, v1). Hereinafter, the two-dimensional map represented as the UV coordinate system is also referred to as the “UV map”.

The character “A” is arranged on the surface of the three-dimensional model M illustrated in FIG. 6.

When the shape data of the three-dimensional model M is given in advance, the correspondence relationship between the coordinates in the MN coordinate system and the coordinates in the XYZ coordinate system of a multi-viewpoint captured image (an image obtained by capturing the three-dimensional model M from a different viewpoint) can be acquired by matching a feature point in the multi-viewpoint image and a feature point in a rendering image of the three-dimensional model M.

When the shape data of the three-dimensional model M is not given in advance, the correspondence relationship between the coordinates in the MN coordinate system and the coordinates in the XYZ coordinate system is acquired by photogrammetry processing.

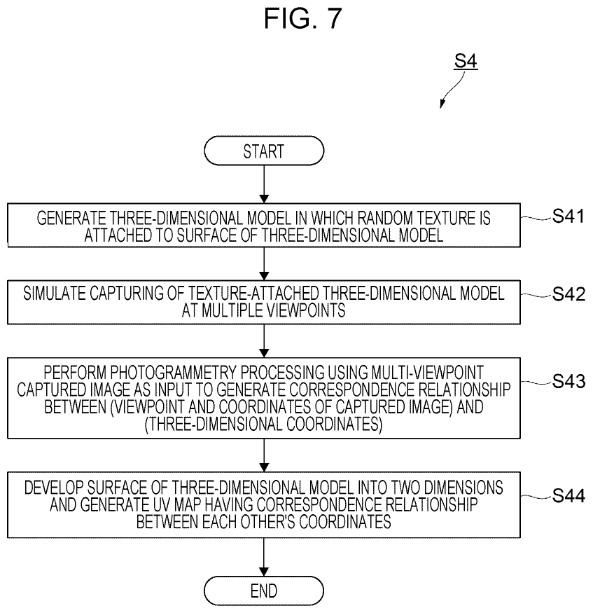

FIG. 7 is a flowchart illustrating an example of a processing operation executed in step S4 (see FIG. 5). The processing operation in FIG. 7 is executed when the shape data of the three-dimensional model M is not given in advance.

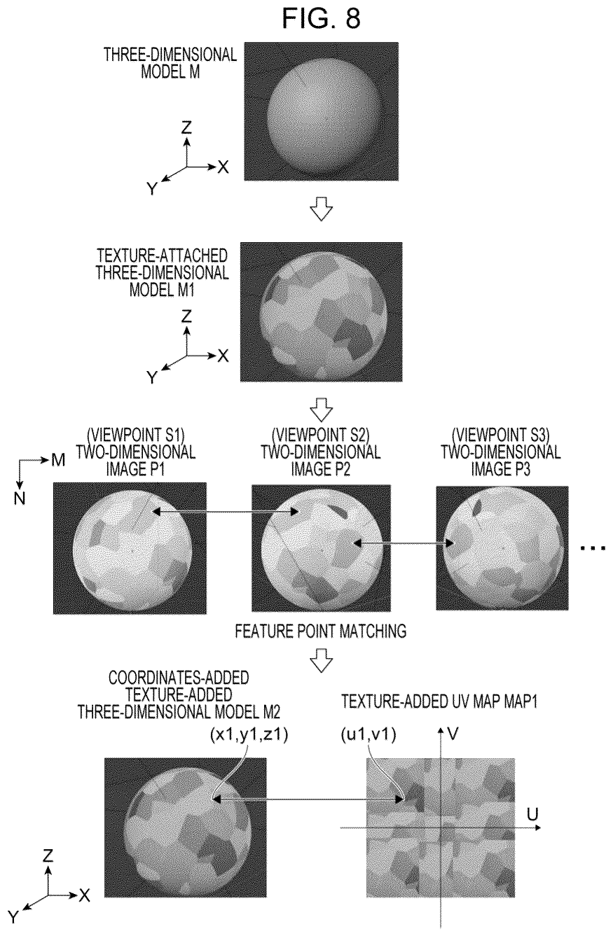

FIG. 8 is a diagram illustrating simulation processing executed in FIG. 7.

First, the processor 111 generates a three-dimensional model (hereinafter referred to as “texture-attached three-dimensional model”) M1 in which a random texture is attached to the surface of the three-dimensional model M (step S41). In the case of FIG. 8, the three-dimensional model M is a sphere without patterns. In the case of FIG. 8, a colored random texture is attached to the three-dimensional model M so that a feature point can be detected.

For the colored random texture, for example, different colors are assigned to adjacent textures. Small regions constituting the random texture are given as, for example, polygonal random patterns. The colored random texture gives feature points to the surface of the three-dimensional model M, which is a sphere without patterns. At this stage, the relationship between the coordinates of the attached random texture and the coordinates on the three-dimensional model M may be unknown.

Subsequently, the processor 111 simulates capturing of the texture-attached three-dimensional model M at multiple viewpoints (step S42). Specifically, a plurality of images (i.e., multi-viewpoint captured images) obtained by capturing the three-dimensional model M in the simulation space from different viewpoints i is generated by the simulation processing.

Subsequently, the processor 111 performs photogrammetry processing using the multi-viewpoint captured image as an input to generate the correspondence relationship between (the viewpoint and the coordinates of the captured image) and (the three-dimensional coordinates) (step S43).

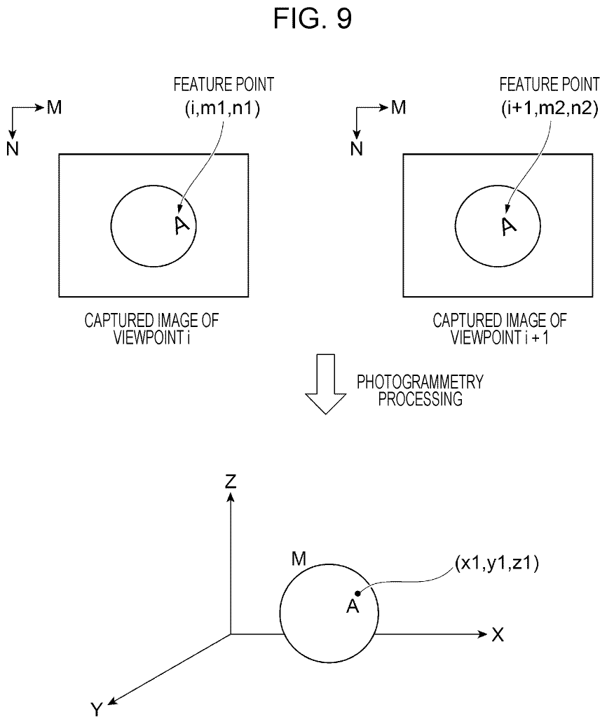

FIG. 9 is a diagram illustrating the photogrammetry processing.

First, a feature point (e.g., the character A) is matched between the captured image at the viewpoint i and the captured image at the viewpoint i+1. In FIG. 9, the coordinates of the feature point in the captured image at the viewpoint i are (i, m1, n1), and the coordinates of the feature point in the captured image at the viewpoint i+1 are (i+1, m2, n2).

In FIG. 8, a feature point is matched between a two-dimensional image P1 at a viewpoint S1 and a two-dimensional image P2 at a viewpoint S2. Similarly, a feature point is matched between the two-dimensional image P2 at the viewpoint S2 and a two-dimensional image P3 at a viewpoint S3. That is, feature points are matched with each other between captured images at multiple viewpoints.

In the two-dimensional images P1 to P3 illustrated in FIG. 8, since the texture-attached three-dimensional model M1 is captured from different viewpoints, different surface portions of the texture-attached three-dimensional model M1 are captured.

Since capturing is performed in the simulation space, the influence of the light of the light source is ignored. The virtual camera captures the surface of the texture-attached three-dimensional model M1 appearing within the angle of view as it is.

In the case of FIG. 8, the multi-viewpoint texture images P1, P2, P3 . . . are captured by rotating the texture-attached three-dimensional model M1 while the virtual camera is fixed. The multi-viewpoint texture images P1, P2, P3 . . . may be captured while the position of the three-dimensional model M1 is fixed and the virtual camera is moved.

Subsequently, the processor 111 uses the coordinates of the camera in the simulation space and the coordinates (i, m1, n1) and (i+1, m2, n2) of the feature points in the two captured images to estimate the coordinates (x1, y1, z1) of the feature point in the three-dimensional model M in manner of trigonometrical survey.

In FIG. 8, a coordinates-added texture-added three-dimensional model M2 is generated. Thus, the correspondence relationship between the coordinates of the multi-viewpoint captured image in the coordinate system (i.e., the MN coordinate system) and the coordinates of the three-dimensional model M in the XYZ coordinate system is acquired.

With this correspondence relationship, the coordinates of the multi-viewpoint specular image can be projected onto the coordinates of a UV map described below through the coordinates of the three-dimensional model M.

A reference is made back to the description of FIG. 7.

Subsequently, the processor 111 develops the surface of the three-dimensional model M into two dimensions and generates a UV map having the correspondence relationship between each other's coordinates (step S44).

In the case of FIG. 8, a texture-added UV map MAP1 having the correspondence relationship with the coordinates of the coordinates-added texture-added three-dimensional model M2 is generated.

In the texture-added three-dimensional model M2, the position of each texture is identified as the coordinates in the XYZ coordinate system.

The texture-added UV map is a map obtained by two-dimensionally developing the coordinates-added texture-added three-dimensional model M2.

There is a one-to-one correspondence relationship between the coordinates (x1, y1, z1) of the coordinates-added texture-added three-dimensional model M2 and the coordinates (u1, v1) of the texture-added UV map.

The correspondence relationship in step S44 is the correspondence relationship between the coordinates in the XYZ coordinate system and the coordinates in the UV coordinate system and is different from the correspondence relationship between the coordinates in the MN coordinate system and the coordinates in the XYZ coordinate system. When the two are distinguished from each other, the former is referred to as a first correspondence relationship, and the latter as a second correspondence relationship.

### <Processing Contents of Steps S5 to S7>

A reference is made back to the description of FIG. 5.

The processor 111 sets a texture parameter for specular reflection on the surface of the three-dimensional model M (step S5). In the three-dimensional model M, only the surface shape in the simulation space is defined. For this reason, the texture parameter for specular reflection is set in step S5. The value of the texture parameter for specular reflection is uniform within the set range. According to the present exemplary embodiment, the texture parameter for specular reflection is set for the entire surface of the three-dimensional model M.

Subsequently, the processor 111 generates a three-dimensional model M11 reflecting the texture parameter of specular reflection by rendering (step S6).

Subsequently, the processor 111 generates specular reflection images P11, P12, P13 . . . obtained by capturing the generated three-dimensional model M11 at multiple viewpoints for each combination of the virtual light sources V11 to V15 that are turned on (step S7).

For example, there are 31 combinations of the virtual light sources V11 to V15. According to the present exemplary embodiment, only one of the virtual light sources V11 to V15 is sequentially turned on, and a plurality of multi-viewpoint specular reflection images MVP11(N), MVP12(N), MVP13(N), MVP14(N), and MVP15(N) is captured for the respective virtual light sources V11 to V15. The maximum value of N is the maximum number of images to be captured.

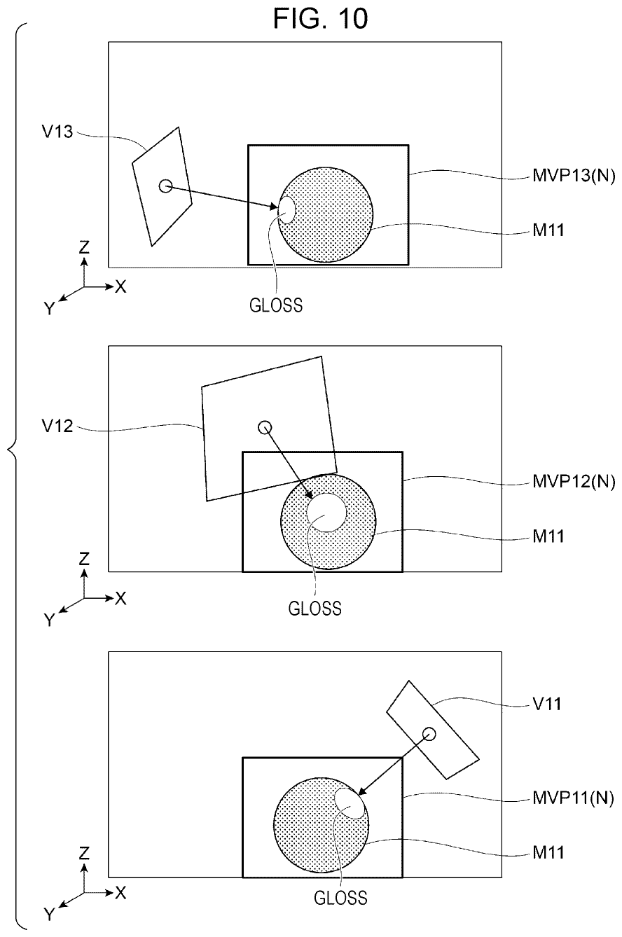

FIG. 10 is a diagram illustrating the multi-viewpoint image MVP11 of the three-dimensional model M11 reflecting the texture parameter of specular reflection.

FIG. 10 displays one specular reflection image extracted from each of the specular reflection images MVP11(N) to MVP13(N) corresponding to the three virtual light sources V11 to V13 among the virtual light sources V11 to V15. Basically, the glossy feeling appears on a surface portion of the three-dimensional model M11 where the positional relationship between the virtual camera and the virtual light source satisfies a specular reflection condition.

The uppermost section of FIG. 10 illustrates one of the plurality of multi-viewpoint images MVP13(N) captured when only the virtual light source V13 is turned on. The middle section of FIG. 10 illustrates one of the plurality of multi-viewpoint images MVP12(N) captured when only the virtual light source V12 is turned on. The lowermost section of FIG. 10 illustrates one of the plurality of multi-viewpoint images MVP11(N) captured when only the virtual light source V11 is turned on.

The multi-viewpoint images MVP14(N) captured when only the virtual light source V14 is turned on and the multi-viewpoint images MVP15(N) captured when only the virtual light source V15 is turned on can also be captured in the same manner.

### <Processing Contents of Step S8>

A reference is made back to the description of FIG. 5.

When the processing of step S4 (or step S44) and the processing of step S7 end, the processor 111 associates the multi-viewpoint specular reflection image MVP acquired for each virtual light source with the UV map to generate a specular reflection UV map (step S8). The specular reflection UV map is an example of a two-dimensional specular reflection map.

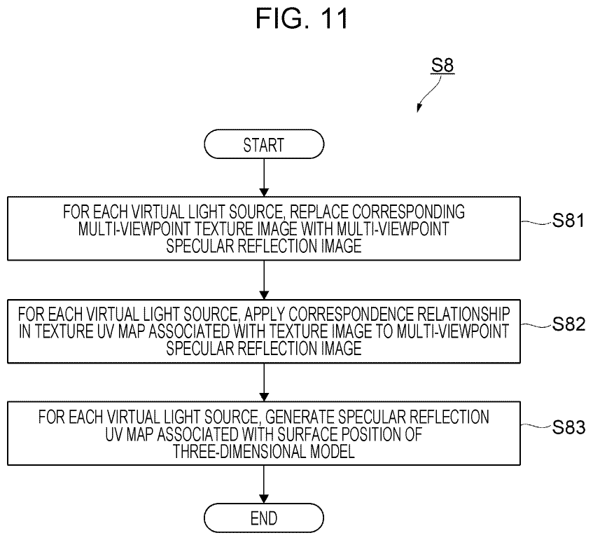

FIG. 11 is a flowchart illustrating an example of a processing operation executed in step S8 (see FIG. 5).

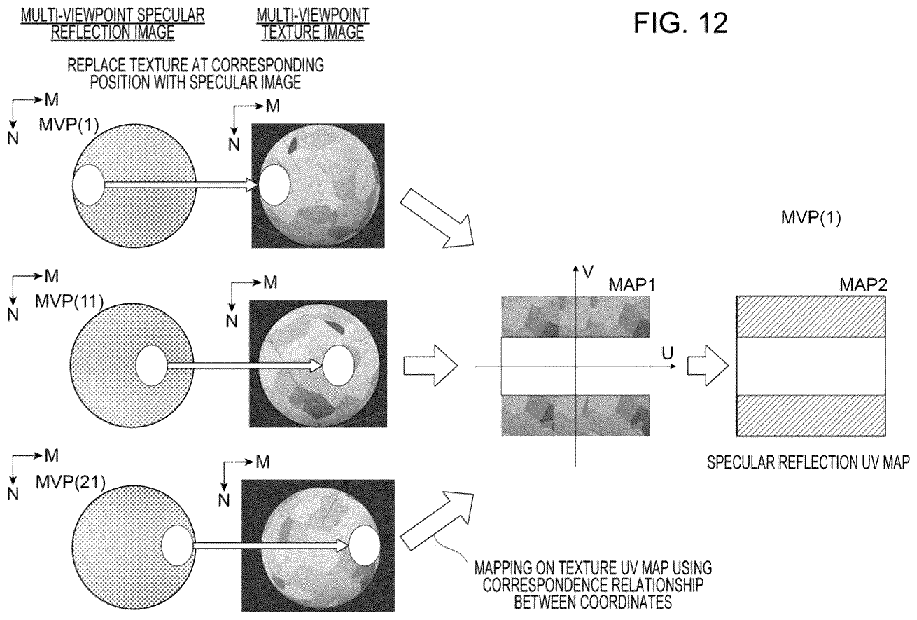

FIG. 12 is a diagram illustrating a processing image of step S8 (see FIG. 5).

First, for each virtual light source, the processor 111 replaces the corresponding multi-viewpoint texture image with the multi-viewpoint specular reflection image MVP (step S81). FIG. 12 illustrates three specular reflection images MVP(1), MVP(11), and MVP(21) among the multi-viewpoint specular reflection images MVP(N) captured when the virtual light source V13 is turned on.

In FIG. 12, for example, between the multi-viewpoint specular reflection images MVP(N) and the multi-viewpoint texture images P1, P2, P3 . . . with the same rotation angle, some of the texture images are replaced with specular reflection images.

Subsequently, for each virtual light source, the processor 111 applies the correspondence relationship (i.e., the coordinates (u1, v1) in the UV coordinate system) in the texture UV map associated with the texture image to the multi-viewpoint specular reflection image MVP (step S82).

Subsequently, for each virtual light source, the processor 111 generates a specular reflection UV map MAP2 associated with the surface position of the three-dimensional model M2 (step S83). The correspondence relationship between the coordinates is stored between the UV map MAP1 serving as the base of the generated specular reflection UV map MAP2 and the coordinates-added texture-added three-dimensional model M2.

### <Step S9>

A reference is made back to the description of FIG. 5.

When step S8 ends, the processor 111 attaches the generated specular reflection UV map MAP2 (see FIG. 12) to the three-dimensional model M2 (see FIG. 8) to visualize the specular reflection region (step S9).

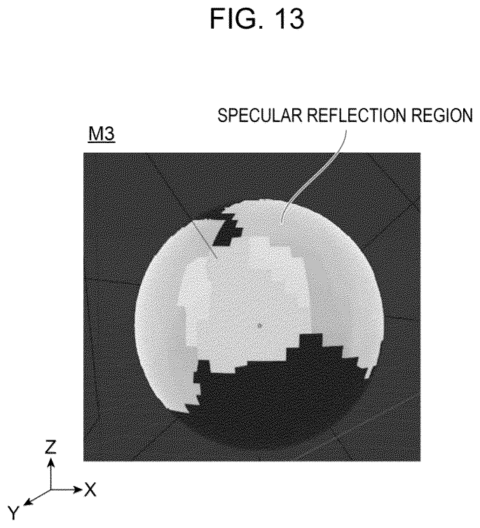

FIG. 13 is a diagram illustrating an example of a three-dimensional model (hereinafter also referred to as the “three-dimensional visualization model of the specular reflection region”) M3 obtained by visualizing a specular reflection region. In FIG. 13, the specular reflection region on the rear surface side is also represented in a transparent manner.

On the entire surface of the three-dimensional visualization model M3 of the specular reflection region, the specular reflection region observed when a specific light source is turned on is mapped. Therefore, the specular reflection region can be checked from any direction within the simulation space.

When two or more of the virtual light sources V11 to V15 are turned on, the specular reflection UV map MAP2 corresponding to the combination of lighting positions can be generated as a composite map of the specular reflection UV maps MAP2 corresponding to the lighting positions.

Since the base of the composite map is the specular reflection UV map MAP2, the coordinates (u1, v1) of the composite map can be associated with the coordinates (x1, y1, z1) of the coordinates-added texture-added three-dimensional model M2 (see FIG. 8). That is, the three-dimensional visualization model M3 of the specular reflection region can also be generated from the composite map.

The simulation apparatus 110 (see FIG. 3) according to the present exemplary embodiment can display the specular cover rate for each light source by using the three-dimensional visualization model of the specular reflection region. The specular cover rate is the area ratio of the region where the specular reflection region is observed when the light source is turned on to the entire surface.

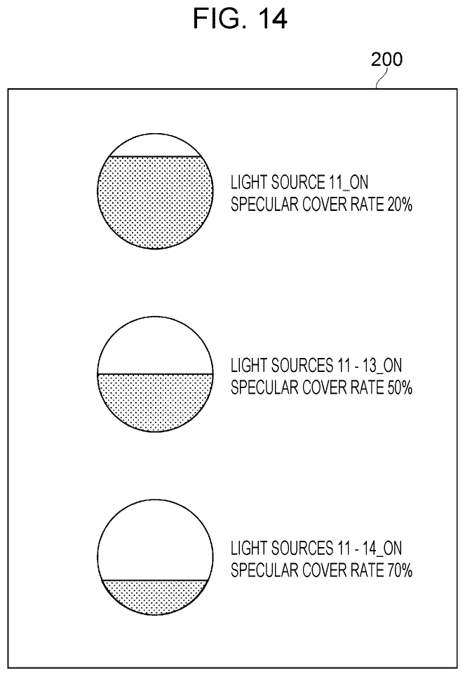

FIG. 14 is a diagram illustrating a display example of a specular cover rate screen 200. The specular cover rate screen 200 is generated using the three-dimensional visualization model M3 of the specular reflection region generated for each virtual light source.

The specular cover rate screen 200 illustrated in FIG. 14 displays specular cover rates for three lighting patterns.

First, when only the light source 11 is turned on (that is, illuminated), the specular cover rate is 20%. When the three light sources 11 to 13 are turned on (that is, lighted), the specular cover rate is 50%. When the four light sources 11 to 14 are turned on (that is, lighted), the specular cover rate is 70%.

Although the adjacent light sources are turned on (that is, lighted) together in FIG. 14, it is possible to display the specular cover rate in a case where, for example, the light sources 11, 13, and 15 are turned on (that is, lighted).

While only three lighting patterns are displayed on the specular cover rate screen 200 in FIG. 14 for the sake of convenience of description, the specular cover rate may be displayed for all the lighting patterns that can be combined.

Alternatively, only the specular cover rate corresponding to a combination of lighting patterns designated by the user may be displayed.

### <Summary>

With the use of the simulation technology described in the present exemplary embodiment, it is possible to visualize the specular reflection region of the three-dimensional model M that can be captured for each combination of the lighting positions of the light sources 11 to 15 (see FIG. 1). As a result, for each combination of the positions of the light sources to be turned on, the area ratio at which the specular reflection regions appear can be checked as a numerical value.

### Second Exemplary Embodiment

The use of the specular cover rate screen 200 illustrated in FIG. 14 makes it possible to check the specular cover rate for each lighting pattern for each shape (e.g., a sphere, a cylinder, a torus, or a figure) of the three-dimensional model M that is an observation target.

On the other hand, a user who uses the gloss reading system 1 (see FIG. 1) may want to know the arrangement of light sources capable of reading gloss regardless of the observation target.

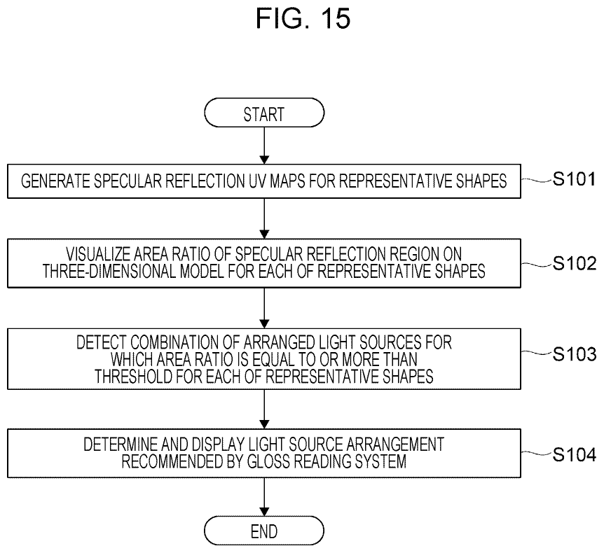

FIG. 15 is a flowchart illustrating processing to determine light source arrangement.

The processing operations illustrated in FIG. 15 are performed through program execution by the processor 111 (see FIG. 4).

First, the processor 111 generates specular reflection UV maps for a plurality of representative shapes (step S101). Examples of the representative shape include a sphere, a cylinder, a torus, and a figure.

Subsequently, the processor 111 visualizes the area ratio of the specular reflection region on the three-dimensional model for each of the plurality of representative shapes (step S102).

Subsequently, the combination of arranged light sources for which the area ratio is equal to or more than a threshold (e.g., 70%) for each of the plurality of representative shapes is detected (step S103). When the number of light sources provided in the gloss reading system 1 (see FIG. 1) is five, the arrangement with which a specular reflection region of 70% or more is obtained for each of the plurality of representative shapes is detected from 31 arrangements.

Then, the processor 111 determines and displays the light source arrangement recommended by the gloss reading system 1 (step S104).

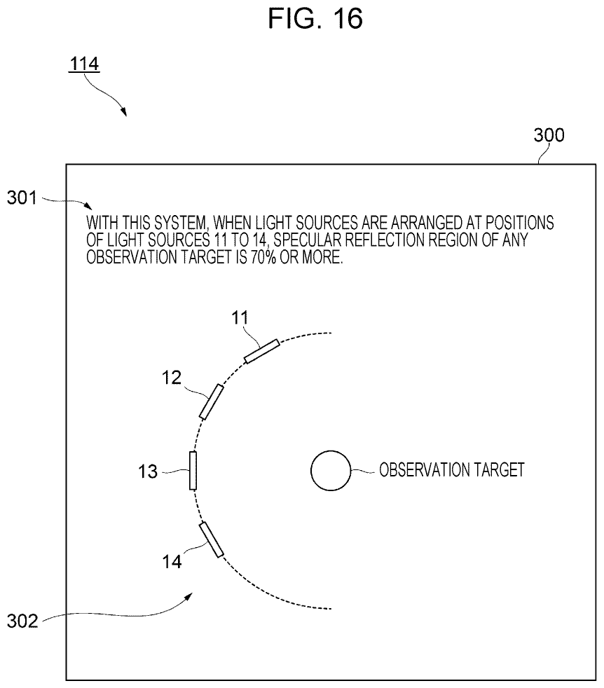

FIG. 16 is a diagram illustrating a recommendation screen 300 for light source arrangement. The recommendation screen 300 for light source arrangement illustrated in FIG. 16 includes a description 301 and an explanatory diagram 302.

In the case of FIG. 16, the description 301 says “With this system, when light sources are arranged at the positions of the light sources 11 to 14, the specular reflection region of any observation target is 70% or more”. The explanatory diagram 302 also illustrates the positions of the light sources 11 to 14 described in the description 301.

The description 301 and the explanatory diagram 302 make it possible for the user to know the light source arrangement recommended by the gloss reading system 1.

The recommendation screen 300 for light source arrangement may include an item for designating or selecting a threshold to be used to determine recommended light source arrangement. For example, when the threshold is changed from 70% to 80%, the recommendation screen 300 may display new light source arrangement.

### <Summary>

With the use of the fact that the three-dimensional visualization model M3 of the specular reflection region is calculated for each light source and each representative shape, the arrangement of light sources with which gloss can be read from the various three-dimensional objects S (see FIG. 1) can be determined and provided to the user.

### Other Exemplary Embodiments

(1) Although the exemplary embodiment of the invention has been described above, the technical scope of the invention is not limited to the scope described in the exemplary embodiment above. It is apparent from the scope of claims that various changes and improvements to the above-described exemplary embodiment are also included in the technical scope of the invention.
(2) With the gloss reading system 1 (see FIG. 1) described in the above exemplary embodiment, it is assumed that gloss information is read while the three-dimensional object S is rotated about the Z-axis with the light sources 11 to 15 (see FIG. 1) and the camera 20 (see FIG. 1) fixed.

However, the three-dimensional object S may be fixed near the rotation center, and the gloss information may be read while the light sources 11 to 15 and the camera 20 are rotated around the three-dimensional object S. In other words, the gloss information of the three-dimensional object S may be read while the light sources 11 to 15 and the camera 20 are revolved with respect to the three-dimensional object S.
(3) According to the second exemplary embodiment described above, the simulation apparatus 110 (see FIG. 3) performs the processing to determine the light source arrangement.

However, when the three-dimensional visualization model M3 of the specular reflection region observed for each light source is accessible, a computer different from the simulation apparatus 110 may execute the processing to determine the light source arrangement.
(4) In the case described according to the above exemplary embodiment, the capturing system 40 (see FIG. 3) and the simulation apparatus 110 (see FIG. 3) are separate systems.

However, the simulation apparatus 110 may be one of the functions executed by the capturing system 40. That is, the simulation apparatus 110 may be integrated with the capturing system 40.

The gloss reading system 1 and the specular reflection region visualization system 100 (see FIG. 3) may constitute a single system.
(5) According to the exemplary embodiment described above, each processing is executed by any computer. In addition, the arbitrary computer may execute each processing by a processor as hardware, a program as software, or a combination thereof.

In this case, the processor is configured to execute various types of processing according to the exemplary embodiment in cooperation with a program and may function as each unit or each means according to the exemplary embodiment.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be configured by a programmable logic device such as a central processing unit (CPU), a micro processing unit (MPU), or a field programmable gate array (FPGA), a dedicated circuit for executing specific processing, such as an application specific integrated circuit (ASIC), or hardware such as a graphic processing unit (GPU) or a neural processing unit (NPU).

Regarding the type of hardware, a combination of different types of hardware may be used. When a plurality of pieces of hardware is configured to execute one or more processes of a certain processor, the plurality of pieces of hardware may exist in devices physically separated from each other, or may exist in the same device. In addition, according to any exemplary embodiment, the order of the processes performed by the processor is not limited to the order described above, and may be appropriately changed. The hardware is composed of an electric circuitry in which circuit elements such as semiconductor devices are combined, or the like.

Further, the program may be software such as firmware or microcode. In addition, the program may be, for example, a program module group, and each function thereof may be realized by a processor configured to execute each function. The program may be a program code or a plurality of code segments stored in one or more non-transitory computer-readable media (e.g., storage media or other storage).

The program may be stored in such a divided manner in multiple non-transitory computer readable media present in apparatuses physically away from each other. The program code or the code segments may represent procedures, functions, subprograms, routines, subroutines, modules, software packages, classes, or any combination of instructions, data structures, or program statements. The program code or the code segment may be connected to another code segment or a hardware circuit by transmitting and/or receiving information, data, an argument, a parameter, or memory content.
(6) The exemplary embodiment of the invention is also applicable to programs and program products.

### Appendix

(((1)))

An information processing system comprising a processor configured to:
arrange a three-dimensional model in a virtual space;
arrange a surface light source that illuminates the three-dimensional model in the virtual space;
arrange a camera that captures the three-dimensional model in the virtual space;
generate a two-dimensional map having a correspondence relationship with a surface of the three-dimensional model;
capture, from multiple viewpoints, a state where the three-dimensional model having a texture parameter for specular reflection set for the entire surface is illuminated by the surface light source and generate a multi-viewpoint specular reflection image:
associate the multi-viewpoint specular reflection image with the two-dimensional map and generate a two-dimensional specular reflection map; and
attach the generated two-dimensional specular reflection map to the three-dimensional model and visualize a specular reflection region.
(((2)))

The information processing system according to (((1))), wherein the processor is configured to
after applying a positioning pattern to the surface of the three-dimensional model, execute capturing from multiple viewpoints and acquire a multi-viewpoint pattern image, and
generate the two-dimensional map associated with the surface of the three-dimensional model from the multi-viewpoint pattern image.
(((3)))

The information processing system according to (((2))), wherein the processor is configured to
replace the multi-viewpoint pattern image with the multi-viewpoint specular reflection image, and
apply a correspondence relationship with the two-dimensional map to the multi-viewpoint specular reflection image after replacement and generate the two-dimensional specular reflection map.
(((4)))

The information processing system according to any one of (((1))) to (((3))), wherein the processor is configured to calculate and display an area ratio of a region where specular reflection is observed to an area of the entire surface of the three-dimensional model.
(((5)))

The information processing system according to any one of (((1))) to (((4))), wherein when the surface light source includes a plurality of surface light sources arranged in the virtual space, the processor is configured to turn on each of the plurality of surface light sources one by one to generate the multi-viewpoint specular reflection image for each of the surface light sources.
(((6)))

The information processing system according to (((5))), wherein the processor is configured to
generate the two-dimensional specular reflection map corresponding to a combination of the plurality of surface light sources as a composite map of the two-dimensional specular reflection map corresponding to each of the surface light sources, and
attach the composite map to the three-dimensional model and visualize the specular reflection region.
(((7)))

A method for determining lighting arrangement, the method comprising:
visualizing, by the information processing system according to claim 1, a specular reflection region of a plurality of representative shapes as the three-dimensional model; and
determining, as lighting arrangement, a combination of arranged surface light sources for which an area ratio of the specular reflection region is equal to or more than a predetermined value for each of the plurality of representative shapes.
(((8)))

A program causing a computer to execute a process comprising:
arranging a three-dimensional model in a virtual space;
arranging a surface light source that illuminates the three-dimensional model in the virtual space;
arranging a camera that captures the three-dimensional model in the virtual space;
generating a two-dimensional map having a correspondence relationship with a surface of the three-dimensional model;
capturing, from multiple viewpoints, a state where the three-dimensional model having a texture parameter for specular reflection set for the entire surface is illuminated by the surface light source and generating a multi-viewpoint specular reflection image;
associating the multi-viewpoint specular reflection image with the two-dimensional map and generating a two-dimensional specular reflection map; and
attaching the generated two-dimensional specular reflection map to the three-dimensional model and visualizing a specular reflection region.

What is claimed is:

1. An information processing system comprising:
a processor configured to:
arrange a three-dimensional model in a virtual space;
arrange a surface light source that illuminates the three-dimensional model in the virtual space;
arrange a camera that captures the three-dimensional model in the virtual space;
generate a two-dimensional map having a correspondence relationship with a surface of the three-dimensional model;
capture, from multiple viewpoints, a state where the three-dimensional model having a texture parameter for specular reflection set for the entire surface is illuminated by the surface light source and generate a multi-viewpoint specular reflection image;
associate the multi-viewpoint specular reflection image with the two-dimensional map and generate a two-dimensional specular reflection map; and
attach the generated two-dimensional specular reflection map to the three-dimensional model and visualize a specular reflection region.

2. The information processing system according to claim 1, wherein the processor is configured to:
after applying a positioning pattern to the surface of the three-dimensional model, execute capturing from multiple viewpoints and acquire a multi-viewpoint pattern image; and
generate the two-dimensional map associated with the surface of the three-dimensional model from the multi-viewpoint pattern image.

3. The information processing system according to claim 2, wherein the processor is configured to:
replace the multi-viewpoint pattern image with the multi-viewpoint specular reflection image; and
apply a correspondence relationship with the two-dimensional map to the multi-viewpoint specular reflection image after replacement and generate the two-dimensional specular reflection map.

4. The information processing system according to claim 1, wherein the processor is configured to calculate and display an area ratio of a region where specular reflection is observed to an area of the entire surface of the three-dimensional model.

5. The information processing system according to claim 1, wherein when the surface light source includes a plurality of surface light sources arranged in the virtual space, the processor is configured to turn on each of the plurality of surface light sources one by one to generate the multi-viewpoint specular reflection image for each of the surface light sources.

6. The information processing system according to claim 5, wherein the processor is configured to:
generate the two-dimensional specular reflection map corresponding to a combination of the plurality of surface light sources as a composite map of the two-dimensional specular reflection map corresponding to each of the surface light sources; and
attach the composite map to the three-dimensional model and visualize the specular reflection region.

7. A method for determining lighting arrangement, the method comprising:
visualizing, by the information processing system according to claim 1, a specular reflection region of a plurality of representative shapes as the three-dimensional model; and
determining, as lighting arrangement, a combination of arranged surface light sources for which an area ratio of the specular reflection region is equal to or more than a predetermined value for each of the plurality of representative shapes.

8. A non-transitory computer readable medium storing a program causing a computer to execute a process comprising:
arranging a three-dimensional model in a virtual space;
arranging a surface light source that illuminates the three-dimensional model in the virtual space;
arranging a camera that captures the three-dimensional model in the virtual space;
generating a two-dimensional map having a correspondence relationship with a surface of the three-dimensional model;
capturing, from multiple viewpoints, a state where the three-dimensional model having a texture parameter for specular reflection set for the entire surface is illuminated by the surface light source and generating a multi-viewpoint specular reflection image;
associating the multi-viewpoint specular reflection image with the two-dimensional map and generating a two-dimensional specular reflection map; and
attaching the generated two-dimensional specular reflection map to the three-dimensional model and visualizing a specular reflection region.
